(19) United States
(12) Patent Application Publication
(10) Pub. No.: US 2013/0247737 A1
(43) Pub. Date: Sep. 26, 2013

(54) CUTTING INDICATOR FOR CIRCULAR SAW

(71) Applicant: REXON INDUSTRIAL CORP., LTD., Taichung (TW)

(72) Inventor: Jung-Huo CHEN, Taichung (TW)

(73) Assignee: Rexon Industrial Corp., Ltd., Taichung (TW)

(21) Appl. No.: 13/849,927

(22) Filed: Mar. 25, 2013

(30) Foreign Application Priority Data
Mar. 26, 2012 (TW) 101110400

(51) Int. Cl. B23D 59/00; B23D 45/04

(52) U.S. Cl. CPC B23D 59/003; B23D 45/044
USPC 83/471.3; 83/521

(57) ABSTRACT

A cutting indicator includes an adjusting base pivotally mounted to a saw arm of a circular saw, a lens mounted in the saw arm, and a laser generator mounted on the adjusting base. When a laser beam generated by the laser generator passes through the lens, the laser beam is converted to a laser plane that forms a laser indicating line on the workpiece to be cut by the circular saw. Adjusting the adjusting base causes the plane beam to be quickly switched between a predetermined first plane position and a predetermined second plane position that are aligned substantially parallel to two opposing lateral planes of the circular saw blade. Thus, quick adjustment of the laser indicating line can be easily achieved.

### CROSS REFERENCE TO RELATED APPLICATION(S)

This application claims, under 35 U.S.C. § 119, priority to Taiwanese Application No. 101110400, filed Mar. 26, 2012, which application is hereby incorporated by reference in its entirety, inclusive of the specification, claims, and drawings.

### FIELD OF THE INVENTION

The present disclosure relates to circular saws and more particularly, to a cutting indicator for circular saw.

### BACKGROUND

Before operating a circular saw to cut a workpiece, the user can mark a cutting line on the workpiece, and then lower the circular saw blade to touch the workpiece for visually checking the alignment. After the alignment has been checked, the circular saw is operated to cut the workpiece along the marked cutting line. However, only a small part of the circular saw blade can be aimed at the marked cutting line during alignment between the circular saw blade and the marked cutting line due to the limitation of the shape of the circular saw blade, and thus an error can easily occur, resulting in an inaccurate cutting size. Therefore, regular circular saws are commonly equipped with a cutting indicator that can be controlled to emit a laser beam, forming a laser indicating line on the surface of the workpiece. Subject to the indication of the laser indicating line, the circular saw blade can be operated to cut the workpiece accurately.

However, prior to the workpiece cutting operation, the user normally needs to make a 3-dimensional adjustment to the cutting indicator. To accomplish this, the user first needs to adjust the laser beam projection angle, and then keep the laser indicating line formed by the laser beam parallel to the workpiece cutting line. Finally, the user must move the laser indicating line into alignment with the workpiece cutting line. After these three adjustment steps are accurately done, the user can then start operating the circular saw to cut the workpiece.

For example, China Patent Publication No. CN201058385 discloses a circular saw, entitled “Saw Cutting Machine”, which teaches a first step of rotating a screw nail 35S to assure parallel alignment between the plane beam LP and the circular saw blade 23, a second step of rotating a screw nail 38S to assure parallel alignment between the line of light LPL and the circular saw blade 23, and a third step of rotating a screw nail 34 to assure positioning of the circular saw blade 23 within the width of the plane beam LP, or to enable the plane beam LP to be positioned adjacent to one side of the circular saw blade 23. In these aforementioned techniques, the lens for converting the emitted laser beam to a plane beam is directly mounted in the laser module. When an adjustment of the laser indicating line is necessary, the user must use a tool to rotate the screw nails 35S, 38S, 34, respectively. These techniques also have the drawback of a low adjustment speed. Further, adjustment in each dimension may affect one another due to the constraint of the design of the laser module itself, resulting in user confusion about the cognitive dimensions. This adjustment method likely causes considerable trouble and inconvenience for unfamiliar users since user skills also determine the effects on the adjustment.

### SUMMARY

The present disclosure has been accomplished under the circumstances in view. It is the main object of the present disclosure to provide a cutting indicator for a circular saw, which facilitates simple and quick adjustment.

To achieve this and other objects of the present disclosure, a cutting indicator comprises an adjusting base, a lens, and a laser generator. The adjusting base is pivotally mounted to a saw arm of a circular saw by a pivot bolt, defining a through hole therein. The lens is mounted at the saw arm corresponding to the adjusting base. The laser generator is mounted in the through hole of the adjusting base, and adapted to generate a laser beam. Thus, when the laser beam generated by the laser generator passes the lens, it is converted to a plane beam, thereby forming a laser indicating line on the workpiece to be cut.

Biasing the adjusting base relative to the saw arm allows the plane beam to be quickly switched between a predetermined first plane position and a predetermined second plane position that are substantially aligned parallel to two opposing lateral planes of the circular saw blade of the circular saw. Thus, quick adjustment of the laser indicating line can be easily achieved.

Preferably, the cutting indicator further comprises a rotary knob rotatably mounted in the adjusting base and connected with the laser generator for adjusting the laser beam projection angle.

Further, the lens can be adjustably mounted in the saw arm for obtaining the optimal plane beam. Alternatively, the lens can be affixed to the saw arm after calibration.

### BRIEF DESCRIPTION OF THE DRAWINGS

These and other features, aspects, and advantages of the present disclosure will become better understood with regard to the following description, appended claims, and accompanying drawings.

FIG. 1 is a side plan view of a circular saw equipped with a cutting indicator in accordance with the present disclosure.

FIG. 2 is an exploded view of the cutting indicator in accordance with the present disclosure.

FIG. 3 is a side plan view of the circular saw of FIG. 1, illustrating a status of use of the cutting indicator.

FIG. 4 is a schematic sectional view of the adjusting base of the present disclosure, illustrating the condition of the rotary knob before being rotated.

FIG. 5 is a schematic sectional view according to FIG. 4, illustrating the rotary knob after being rotated.

FIG. 6 is a schematic top plan view of the present disclosure, illustrating a first relationship between the plane beam and the two lateral planes of the circular saw blade.

FIG. 7 is a schematic top plan view of the present disclosure, illustrating a second relationship between the plane beam and the two lateral planes of the circular saw blade.

FIGS. 8A and 8B illustrate the relative positions among the two lateral planes of the circular saw blade, the workpiece and the plane beam based on different predetermined plane positions.

FIGS. 9A and 9B illustrate the relative positions among the two lateral planes of the circular saw blade, the workpiece and the plane beam based on different predetermined plane positions.

It should be noted that the drawing figures are not necessarily drawn to scale, but instead are drawn to provide a better understanding of the components thereof, and are not intended to be limiting in scope, but rather to provide exemplary illustrations. It should further be noted that the figures illustrate exemplary embodiments of a cutting indicator for a circular saw and the components thereof, and in no way limit the structures or configurations of a cutting indicator for a circular saw and components thereof according to the present disclosure.

### DETAILED DESCRIPTION

Other and further advantages and features of the present disclosure will be understood by reference to the following specification in conjunction with the accompanying drawings.

While the disclosure is susceptible to various modifications and alternative constructions, certain illustrative embodiments are shown in the drawings and are described in detail below. It should be understood, however, that there is no intention to limit the disclosure to the specific embodiments disclosed, but on the contrary, the intention is to cover all modifications, alternative constructions, combinations, and equivalents falling within the spirit and scope of the disclosure.

It will be understood that, unless a term is expressly defined in this disclosure to possess a described meaning, there is no intent to limit the meaning of such term, either expressly or indirectly, beyond its plain or ordinary meaning

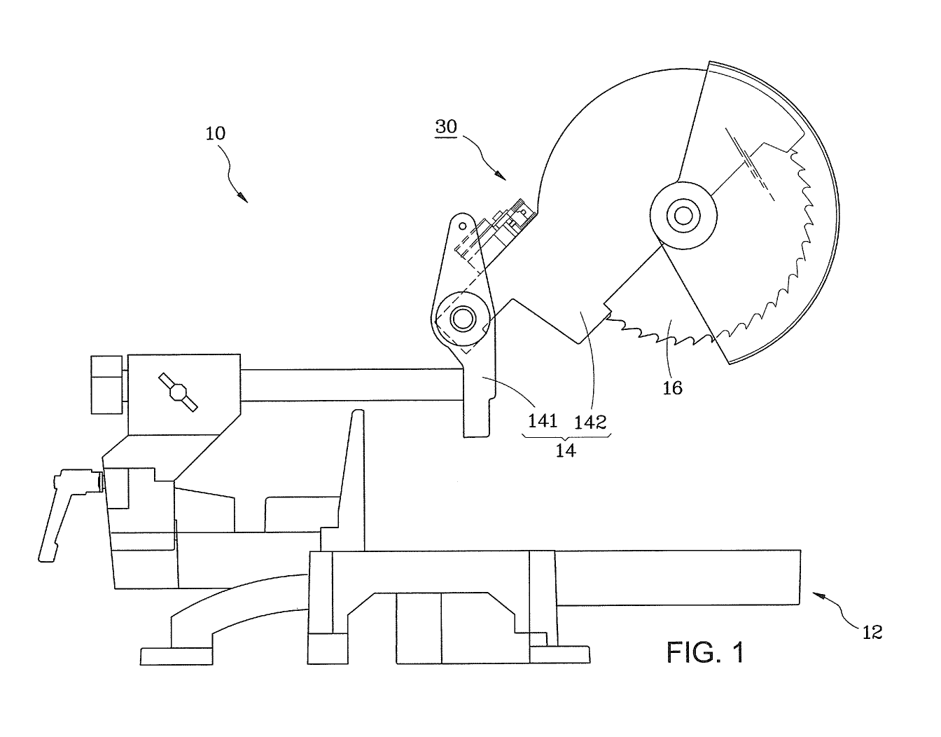

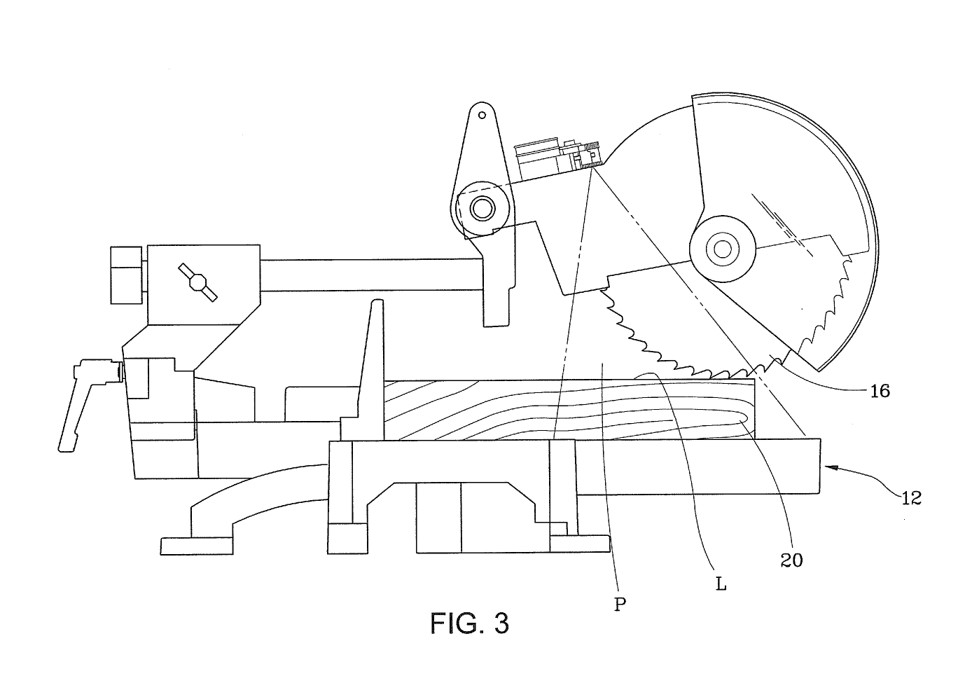

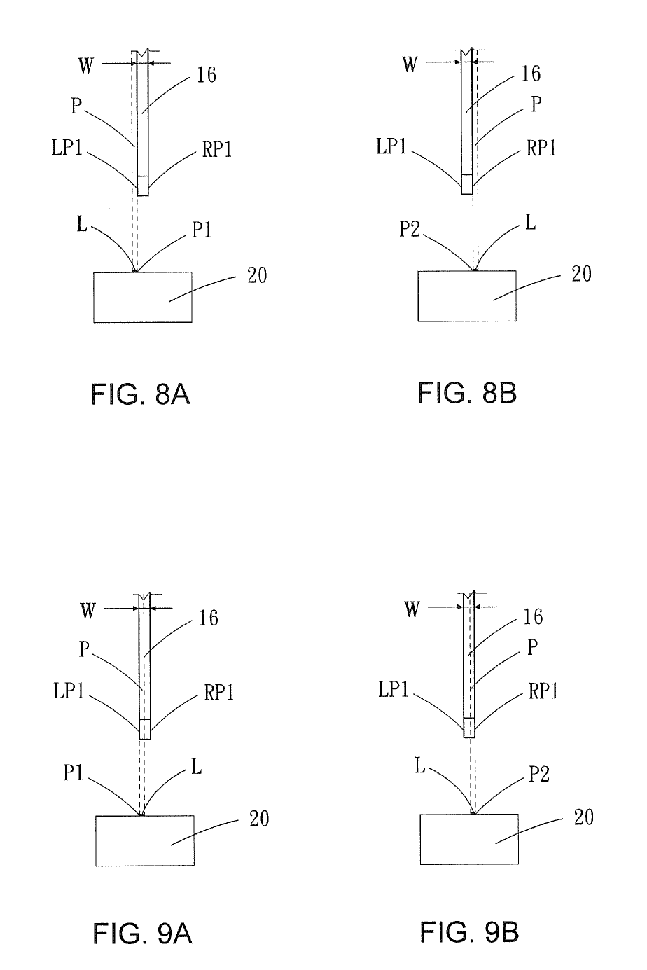

Referring to FIG. 1, a cutting indicator 30 is shown used in a circular saw 10, which comprises a worktable 12, a saw arm 14, and a circular saw blade 16. The saw arm 14 comprises a support base 141, and a circular saw blade holder 142. The support base 141 is mounted at the worktable 12, and the circular saw blade holder 142 is pivotally coupled to the support base 141. The circular saw blade 16 is rotatably supported on the saw arm 14, and movable with the saw arm 14 to cut a workpiece 20, as shown in FIG. 3. The circular saw blade 16 is substantially circular in shape, defining a thickness W and two opposing lateral planes LP1, RP1, as shown in FIGS. 8 and 9.

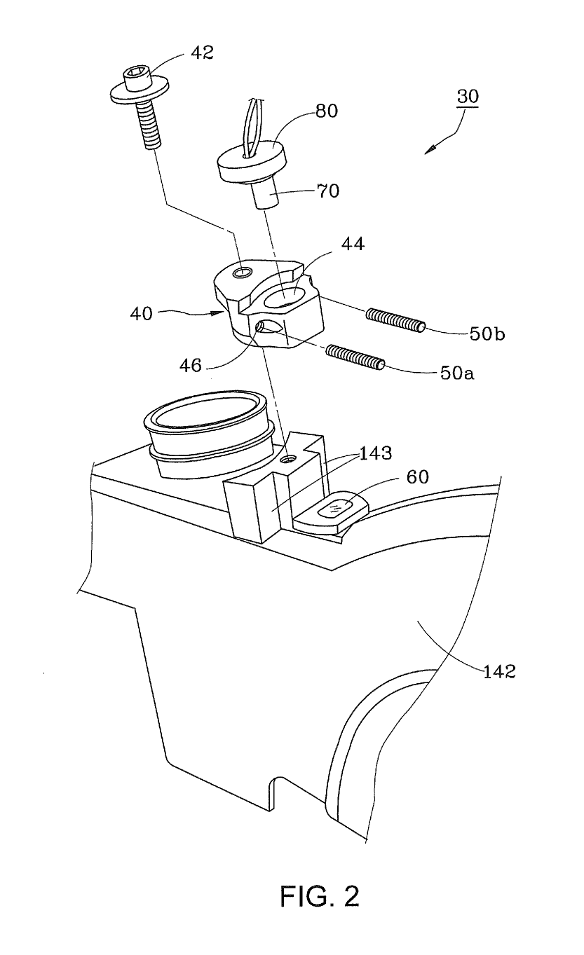

Referring to FIG. 2, the cutting indicator 30 comprises an adjusting base 40, two locating members 50, a lens 60, a laser generator 70, and a rotary knob 80.

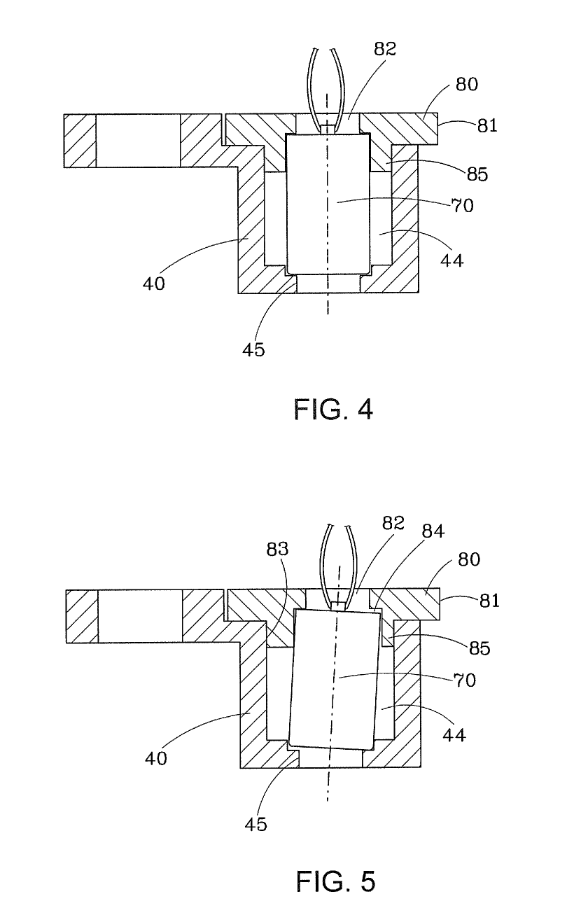

The adjusting base 40 is pivotally connected to the circular saw blade holder 142 of the saw arm 14 by a pivot member, such as a pivot bolt 42. The adjusting base 40 also comprises a through hole 44 cut through opposing top and bottom walls thereof, and a constraint portion 45 radially formed in the through hole 44, as shown in FIGS. 4 and 5. Two longitudinal holes, such as screw holes 46, are respectively and transversely disposed at two opposite lateral sides of the adjusting base relative to the through hole 44. It is to be noted that the adjusting base 40 can be pivotally mounted at the support base 141 of the saw arm 14 subject to fit actual needs.

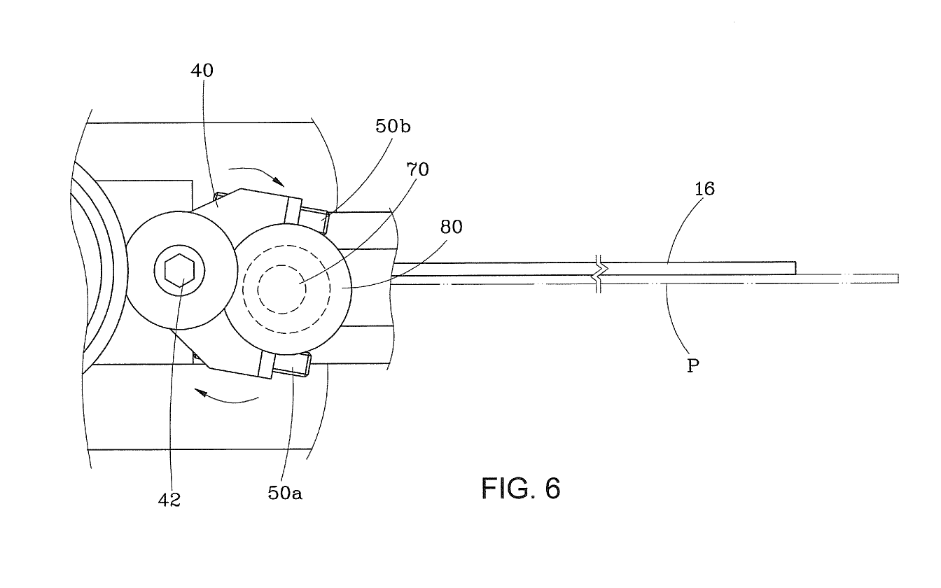

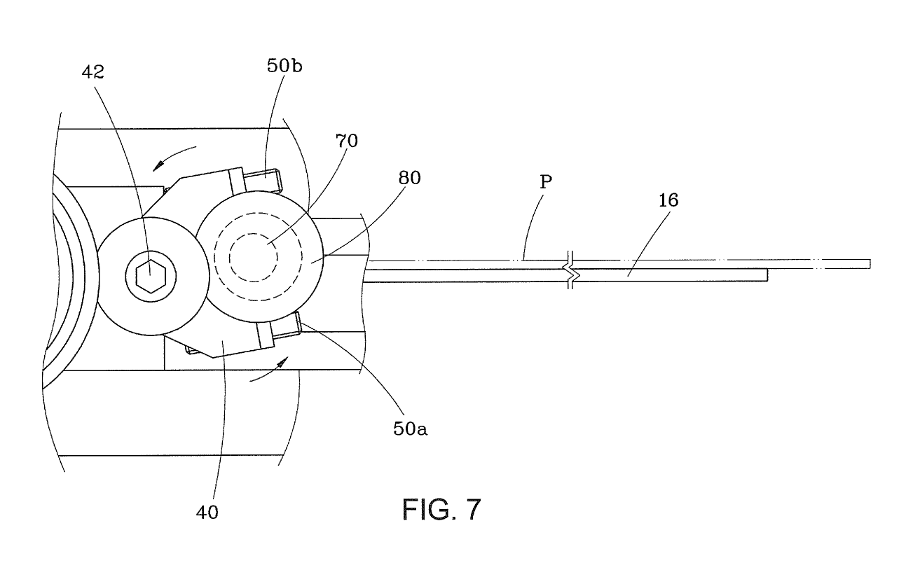

In this embodiment, the two locating members 50 are screw rods 50a, 50b respectively threaded into the screw holes 46 of the adjusting base 40. As shown in FIGS. 6 and 7, at least one of the two screw rods 50a, 50b is arranged to provide a stop against one respective stop wall 143 of the circular saw blade holder 142 to hold the adjusting base 40 in position. It should be understood that positioning of the adjusting base 40 can be achieved by a relative structural design between the adjusting base 40 and the circular saw blade holder 142 instead of the use of the two screw rods 50a, 50b.

The lens 60 in this embodiment may be a wave lens or a serrated lens adjustably mounted in the circular saw blade holder 142 of the saw arm 14, and corresponds to the through hole 44 of the adjusting base 40. The through hole 44 is further adapted to adjust a better planar light beam. Alternatively, the lens 60 can be positioned in the saw arm 14 after calibration, or made in a detachable form to facilitate cleaning and replacement.

The laser generator 70 is mounted in the through hole 44 of the adjusting base 40 and inserted with the bottom end thereof into the constraint portion 45 of the through hole 44. The laser generator 70 is controllable to generate a laser beam in this position. When a laser beam generated by the laser generator 70 passes through the lens 60, the laser beam is converted to a laser plane and projected onto the worktable 12 or the workpiece 20, forming a laser indicating line L, as shown in FIG. 3.

Referring back to FIGS. 4 and 5, the rotary knob 80 comprises an operating head 81 having a thin cylindrical shape rotatably supported on the top wall of the adjusting base 40, and a wire hole 82 cut through opposing top and bottom sides of the operating head 81 for the passing of top power wires of the laser generator 70. A cylindrical receptacle 83 having a varying wall thickness 85 downwardly extends from the bottom side of the operating head 81 and inserts into the through hole 44 of the adjusting base 40. An accommodation hole 84 is eccentrically formed in the cylindrical receptacle 83 in concentric relationship with the wire hole 82 and is surrounded by the varying wall thickness 85. The accommodation hole 84 is further adapted to accommodate the upper end of the laser generator 70. Thus, adjustment of the laser beam projection angle can be achieved by rotating the operating head 81 of the rotary knob 80 to cause the laser generator 70 to be tilted by the varying wall thickness 85 of the cylindrical receptacle 83 such that the constraint portion 45 in the through hole 44 of the adjusting base 40 provides a stop against the laser generator 70, as shown in FIG. 5.

During adjustment, rotating the rotary knob 80 tilts the laser generator 70 due to the eccentric coupling between the laser generator 70 and the rotary knob 80, thereby changing the laser beam projecting angle to the extent where the plane beam P formed by diffusion of the laser beam passed through the lens 60 is aligned parallel to the two lateral planes LP1, RP1 of the circular saw blade 16. At this time, the laser indicating line L formed on the workpiece 20 by the plane beam P is kept in parallel to the cutting line made on the workpiece 20 by the circular saw blade 16. It should be appreciated that if the projection angle of the laser generator 70 is affixed during installation and not allowed for adjustment by the user, then the aforementioned step of rotating the rotary knob, or even the rotary knob 80 itself, can be eliminated.

Thereafter, turning the adjusting base 40 about the pivot bolt 42 enables the plane beam P to be moved in a parallel manner relative to the circular saw blade 16. Thus, the user can adjust the plane beam P to a substantially parallel position relative to the two lateral planes LP1, RP1 of the circular saw blade 16 subject to the thickness of the circular saw blade 16 or other actual needs, as shown in FIGS. 6 and 7. After the position of the plane beam P is assured, a corresponding locating member 50a, 50b is fastened subject to the pivoting direction of the adjusting base 40, thereby controlling the angle of the adjusting base 40. For example, if the adjusting base 40 is biased to the right, the right-sided locating member 50a will be stopped against the circular saw blade holder 142, and the left-sided locating member 50b will be spaced from the respective stop wall 143 of the circular saw blade holder 142, as shown in FIG. 6. At this time, the plane beam P will be formed on the right side relative to the circular saw blade 16. On the contrary, if the adjusting base 40 is biased to the left, the plane beam P will be formed on the left side relative to the circular saw blade 16, as shown in FIG. 7.

After the position of the adjusting base 40 is set, the user can selectively and rapidly switch between a predetermined first plane position P1 and a predetermined second plane position P2 that are substantially aligned parallel to the two lateral planes LP1, RP1 of the circular saw blade 16. In this embodiment, the first plane position P1 and the second plane position P2 are respectively disposed at an outer side relative to the lateral planes LP1, RP1 of the circular saw blade 16, as shown in FIGS. 8A and 8B, or at an inner side relative to the lateral planes LP1, RP1 of the circular saw blade 16, as shown in FIGS. 9A and 9B. After adjustment of the laser indicating line L, the user may start operating the circular saw 10 to cut the workpiece 20.

As stated above, adjusting the position of the plane beam P of the cutting indicator 30 does not need any tools. Simply moving the adjusting base 40 can achieve quick adjustment. Thus, the present invention advantageously simplifies the plane beam adjustment process, thus enhancing convenience for the user.

Although a particular embodiment of the disclosure has been described in detail for purposes of illustration, various modifications and enhancements may be made without departing from the spirit and scope of the disclosure. Accordingly, the disclosure is not to be limited except as by the appended claims.

What is claimed is:

1. A cutting indicator used in a circular saw comprising a worktable, a saw arm pivotally mounted at said worktable and a circular saw blade pivotally mounted to said saw arm and defining two opposing lateral planes, the cutting indicator comprising:
an adjusting base pivotally connected to said saw arm;
a lens mounted in said saw arm corresponding to said adjusting base; and
a laser generator arranged in said adjusting base corresponding to said lens and adapted to generate a laser beam through said lens to form a plane beam on said worktable, said plane beam switchable between a predetermined first plane position and a predetermined second plane position subject to pivoting of said adjusting base relative to said saw arm, said predetermined first and second plane positions aligned substantially parallel to said two lateral planes of said circular saw blade.

2. The cutting indicator as claimed in claim 1, wherein said saw arm comprises two stop walls, and said adjusting base is equipped with two locating members bilaterally inserted through said adjusting base such that one of said locating members is configured to stop against one of said stop walls to hold said adjusting base in a predetermined angular position.

3. The cutting indicator as claimed in claim 2, wherein said adjusting base comprises two screw holes disposed at two opposite lateral sides, and said two locating members are respectively threaded into said screw holes.

4. The cutting indicator as claimed in claim 1, further comprising a rotary knob rotatably mounted in said adjusting base and connected with said laser generator such that rotation of the rotary knob adjusts the laser beam projection angle of said laser generator.

5. The cutting indicator as claimed in claim 4, wherein said rotary knob defines an eccentric accommodation hole, and said adjusting base defines a through hole and a constraint portion radially formed in said through hole, such that an upper end of the laser generator is arranged in said eccentric accommodation hole of said rotary knob and a lower end of the laser generator is inserted through said through hole into said constraint portion.

6. The cutting indicator as claimed in claim 1, wherein said lens is adjustably mounted in said saw arm.

7. The cutting indicator as claimed in claim 1, wherein said lens is detachably mounted in said saw arm.

8. The cutting indicator as claimed in claim 1, wherein said adjusting base is pivotally connected to said saw arm by a pivot bolt.

9. The cutting indicator as claimed in claim 1, wherein said predetermined first and second plane positions are respectively disposed at an outer side relative to the two lateral planes of said circular saw blade.

10. The cutting indicator as claimed in claim 1, wherein said predetermined first and second plane positions are respectively disposed at an inner side relative to the two lateral planes of said circular saw blade.

11. A circular saw assembly for use with a worktable, comprising:
a saw arm mounted to said worktable;
a circular saw blade pivotally mounted to the saw arm and defining two opposing lateral planes; and
a cutting indicator having an adjusting base pivotally connected to the saw arm and defining a through hole, a lens mounted in the saw arm corresponding to the adjusting base, and a laser generator mounted in the through hole of the adjusting base and positioned in alignment with the lens for generating a laser beam through said lens to form a plane beam on the worktable.

12. The circular saw assembly according to claim 11, said saw arm further comprising a support base mounted to the worktable, and a circular saw blade holder pivotally mounted to the support base and rotatably mounted to the circular saw blade, wherein the adjusting base is pivotally mounted to the circular saw blade holder by a pivoting member.

13. The circular saw assembly according to claim 11, the adjusting base further defining a pair of longitudinal holes extending in a direction generally perpendicular to the direction of the through hole, the longitudinal holes located parallel to each other on opposite sides of the through hole.

14. The circular saw assembly according to claim 13, the adjusting base further comprising a pair of locating members, wherein each locating member is movably secured within a corresponding longitudinal hole.

15. The circular saw assembly according to claim 14, the circular saw blade holder further defining a pair of stop walls extending therefrom and located adjacent to the lens, wherein said stop walls are configured to provide a pivot stop for the adjusting base by abutting the corresponding locating members.

16. The circular saw assembly according to claim 12, further comprising a rotary knob rotatably mounted in said adjusting base and connected with said laser generator such that rotation of the rotary knob adjusts the laser beam projection angle of the laser generator.

17. The circular saw assembly according to claim 16, wherein said rotary knob comprises an operating head having a wire hole, and an eccentric accommodation hole for engaging an upper end of the laser generator.

18. The circular saw assembly according to claim 17, wherein the eccentric accommodation hole is formed in concentric relationship with the wire hole and is surrounded by a cylindrical receptacle having a varying wall thickness and extending downwardly from the operating head.

19. The circular saw assembly according to claim 11, the adjusting base further comprising a constraint portion radially formed in the through hole for engaging a lower end of the laser generator.

20. A circular saw assembly for use with a worktable, comprising:
a saw arm having a support base mounted to the worktable and a circular saw blade holder pivotally mounted to the support base and rotatably mounted to a circular saw blade, the circular saw blade defining two opposing lateral planes;
a cutting indicator having an adjusting base defining a through hole and pivotally mounted to the circular saw blade holder by a pivoting member, a lens mounted in the circular saw blade holder and corresponding to the adjusting base, and a laser generator mounted in the through hole of the adjusting base and positioned in alignment with the lens for generating a laser beam through said lens to form a plane beam on the worktable; and
said plane beam switchable between a predetermined first plane position and a predetermined second plane position subject to pivoting of said adjusting base relative to said saw arm, said predetermined first and second plane positions aligned substantially parallel to said two lateral planes of said circular saw blade.
